(19) United States
(12) Patent Application Publication
(10) Pub. No.: US 2023/0271894 A1
(43) Pub. Date: Aug. 31, 2023

(54) COMPOSTING DEVICE AND METHOD FOR PROVIDING COMPOST MATERIAL

(71) Applicant: ALFRED KÄRCHER SE & CO. KG, Winnenden (DE)

(72) Inventors: Christian GÄRTNER, Winnenden (DE); Alexander BRÄNDLE, Winnenden (DE); Johannes LUSCHITZ, Winnenden (DE); Anne OBERLÄNDER, Winnenden (DE)

(21) Appl. No.: 18/177,862

(22) Filed: Mar. 3, 2023

Related U.S. Application Data
(63) Continuation of application No. PCT/EP2021/072368, filed on Aug. 11, 2021.

(30) Foreign Application Priority Data
Sep. 5, 2020 (DE) 10 2020 123 245.4

(51) Int. Cl. C05F 17/60; C05F 17/70; C05F 17/993; C05F 17/957

(52) U.S. Cl. CPC C05F 17/60; C05F 17/70; C05F 17/993; C05F 17/957

(57) ABSTRACT

The invention relates to a composting device for providing compost material from organic material, comprising a drying chamber for receiving organic material to be composted, a heating device located on the drying chamber for heating the organic material located in the drying chamber, a control device for controlling and/or regulating the heating device, and a composting chamber, which is connected to the drying chamber via an opening for material transfer and in which the organic material that has been dried in the drying chamber can be converted into compost material. The invention further relates to a method for providing compost material.

### CROSS-REFERENCE TO RELATED APPLICATIONS

This application is a continuation application of international application number PCT/EP2021/072368, filed on Aug. 11, 2021, and claims the benefit of German application number 10 2020 123 245.4, filed on Sep. 5, 2020, which are incorporated herein by reference in their entirety and for all purposes.

### FIELD OF THE INVENTION

The present invention relates to a composting apparatus for providing compost material from organic material, and a method in this regard.

### BACKGROUND OF THE INVENTION

Composting apparatuses are known in which organic material to be composted is converted to compost material. The organic material to be composted is, in particular, organic wastes, for example food residues from domestic use. Accordingly, the present invention relates in particular to a composting apparatus for domestic use, by means of which, for example, kitchen waste and small plants from a private household can be converted to compost material, for example for domestic utilization. Such a composting apparatus can also be suitable for use in offices, for example.

Composting apparatuses for home use are known in the prior art. For example, US 2008/0209967 A1 describes a composting apparatus comprising a composting chamber. The composting chamber is arranged in a housing. A mixing unit serves for circulating the organic material. The composting chamber can be heated. After the composting process has terminated, the bottom of the composting chamber is opened. The compost material can fall into a receiving container and be removed from the housing there. Water can flow off via a bottom of the composting chamber and be collected in a separate vessel. The composting device can comprise a lock into which material to be composted is introduced and temporarily stored there before it can be introduced via a flap into the composting chamber.

EP 3 275 808 B1 describes a composting apparatus having a composting chamber. The composting chamber is heated at a lower portion and cooled at an upper portion by means of an air flow. In this way, condensate is intended to be formed on an inner wall of the composting chamber, by means of which the inner wall can be cleaned.

Further composting devices are described, for example, in the documents DE 197 49 751 A1, US 2016/0207845 A1, US 2017/0260111 A1, EP 3 007 836 B1 and FR 2792330 A1.

A composting apparatus for industrial applications is described in KR 10-1183135 B1. Said composting apparatus comprises a drum-shaped composting chamber which can be heated. The organic material can be circulated by means of a mixing unit. Compost material can be removed by means of a closable flap after the composting process has terminated.

An object underlying the present invention is to provide a composting apparatus and a method for providing compost material, by means of which compost material can be produced in a user-friendly manner from organic material.

### SUMMARY OF THE INVENTION

In a first aspect of the invention, a composting apparatus is provided for providing compost material from organic material, comprising:
a drying chamber for receiving organic material to be composted;
a heating device located on the drying chamber for heating the organic material located in the drying chamber;
a control device for controlling and/or regulating the heating device; and
a composting chamber, which is connected to the drying chamber via an opening for material transfer and in which the organic material that has been dried in the drying chamber can be converted into compost material.

In a second aspect of the invention, a method is provided for providing compost material from organic material, in particular using a composting apparatus of the type mentioned above or below, the method comprising:
heating and drying organic material to be composted, in a drying chamber;
transferring dried organic material into a composting chamber and converting the material in the composting chamber to form compost material.

### BRIEF DESCRIPTION OF THE DRAWINGS

The foregoing summary and the following description may be better understood in conjunction with the drawing figures, of which:

FIG. 1: is a schematic view of a preferred embodiment of the composting apparatus in accordance with the invention;

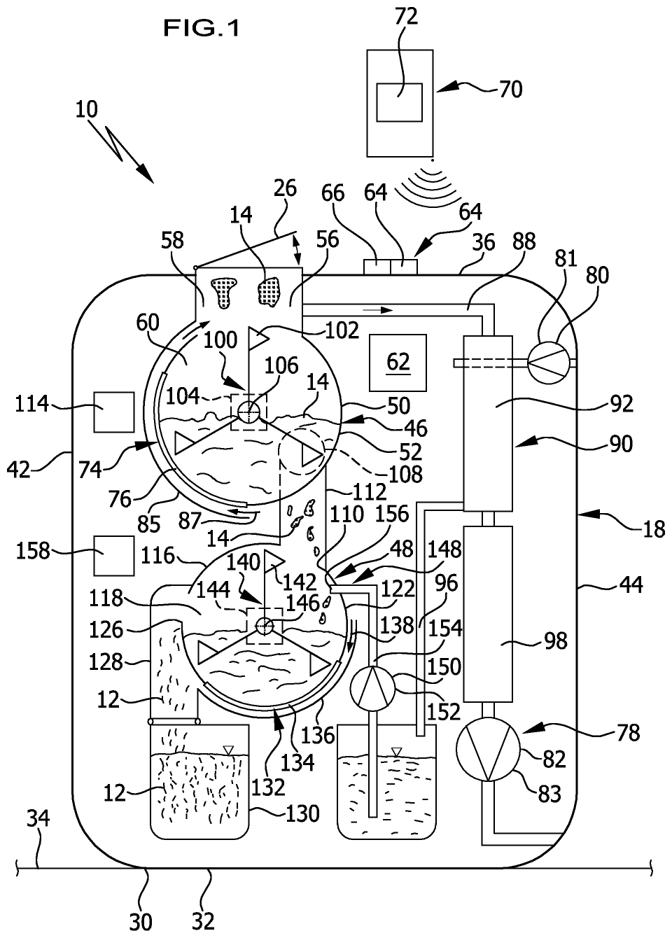

FIG. 2: is a perspective view of the composting apparatus of FIG. 1, some housing parts being faded out;

FIG. 3: is a further perspective view of the composting apparatus from FIG. 1 with the housing open;

FIG. 4: shows a lower housing portion of the composting apparatus of FIG. 1 comprising a removal container for compost material removed from said housing portion; and

FIGS. 5 to 7: are different schematic sectional views of the lower portion, in which a condensate container of the composting apparatus is shown.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a composting apparatus for providing compost material from organic material, comprising:
a drying chamber for receiving organic material to be composted;
a heating device located on the drying chamber for heating the organic material located in the drying chamber;
a control device for controlling and/or regulating the heating device; and
a composting chamber, which is connected to the drying chamber via an opening for material transfer and in which the organic material that has been dried in the drying chamber can be converted into compost material.

In the composting apparatus in accordance with the invention, two chambers are present, in deviation from the conventional composting apparatuses. The composting apparatus comprises a first chamber, which is a drying chamber, and a second chamber, which is the composting chamber. Organic material that is to be composted can be accommodated in the drying chamber, collected therein, and, for example, stored. A heating device, the operation of which can be controlled and/or regulated by the control device, is arranged on the drying chamber. The organic material accommodated in the drying chamber, preferably the drying chamber itself, can be heated using the heating device. This allows the organic material to be dried, it preferably being possible for the degree of drying to be adjustable. The possibility of drying the organic material offers the advantage that uncontrolled decomposition or fermentation with associated odor formation can preferably be avoided. The dried organic material can advantageously also be temporarily stored or stored in the drying chamber for a longer period of time. In a subsequent step, a targeted composting can take place in the composting chamber. In particular, the advantage preferably exists that organic material can remain in the drying chamber without uncontrolled running of the composting process or fermentation, for example if a sufficient amount is to be collected, which is to be supplied to the composting process. After the drying process has elapsed, the dried organic material can be brought via the opening into the composting chamber and the actual composting process can be carried out there, in which the dried organic material is converted to compost material. Preferably, at least two operating modes of the composting apparatus can be provided. In a first operating mode, the organic material is dried and can subsequently be fed to the composting chamber for controlled composting. In a second operating mode, it can be provided that the organic material is dried only to avoid uncontrolled composting processes and fermentation. For example, this material can be removed from the drying chamber and fed to a compost heap or an external composter (“organic waste collection bin”). In a preferred embodiment, the dried material can be transferred into a removal container of the composting apparatus, through the composting chamber, without being transferred into a composting process, the removal container advantageously being able to be removed by the user.

The drying chamber preferably comprises an insertion opening via which organic material can be introduced into the drying chamber. The drying chamber can comprise a chamber wall arrangement and a chamber interior delimited by said chamber wall arrangement. A discharge opening of the drying chamber is advantageously connected to an introduction opening of the composting chamber, alternatively these openings can coincide.

The composting chamber can comprise a chamber wall arrangement and an interior space delimited by the chamber wall arrangement, in which the organic material is accommodated during the composting process. The composting chamber can comprise a discharge opening via which the compost material can be fed for example to a removal container.

It can be provided that the drying chamber and the compost chamber are connected to one another via a channel in order to enable media transfer. The channel can be a shaft, which is oriented for example vertically at least in part, when the drying chamber is arranged above the composting chamber.

Position and orientation information such as “above”, “below” or the like refer in the present case to a use of the composting apparatus as intended. In this case, the composting apparatus is positioned on a set-down surface via a placement device, a contact plane of the composting apparatus coinciding with a plane of the set-down surface. Without limiting the generality, the set-down surface can, for example, be regarded as horizontally oriented.

Advantageously, a wall arrangement of the drying chamber can be heated via the heating device, the wall arrangement advantageously being made of metal. In this way, the heat can be effectively transmitted to the organic material accommodated in the interior.

Drying that is as gentle as possible is found to be advantageous, in which a sufficiently dry material is obtained, although microorganisms contained in the material are not killed. By gentle drying, the highest possible population of different microorganisms in the dried material is advantageously maintained. The microorganisms can subsequently trigger the composting process in the composting chamber and can preferably accelerate said process in the case of a high population. As a result, a high-quality compost can be provided. In a preferred embodiment, for example, this makes it possible to dispense with the addition of microorganisms and/or other types of composting accelerators.

It is advantageous if the composting apparatus comprises a ventilation device via which drying air can be applied to the drying chamber. For example, drying of the material can be promoted by evaporation, via the drying air. Drying air can carry along steam which arises during heating of the organic material. This also allows acceleration of the drying process compared with the use of a heating device alone.

The ventilation device preferably comprises a pressure generating unit and an air guide part, by means of which drying air can be guided into the drying chamber or to an opening of the drying chamber. The pressure generating unit can be designed to produce an overpressure, via which drying air is guided through the air guide part. Alternatively, a pressure generating unit can be provided for forming a negative pressure. Generation of negative pressure, in particular in the drying chamber, may prove advantageous, for example, to prevent odors from escaping. After passing through the drying chamber, drying air can be dehumidified, for example (this will be discussed below) and vented into the atmosphere via a filter element, as a result of which the odor formation of the composting device can be prevented.

The drying air can, for example, flow through the drying chamber or flow into it. Alternatively or in addition, the drying air can flow, for example, past an opening, in particular an introduction opening, of the drying chamber. In both cases, the air guide part allows targeted guidance of the drying air with regard to a best possible drying result.

For example, drying air flows over the organic material in order to be able to entrain rising steam as effectively as possible.

It can be advantageous if the drying air can be heated by means of the heating device. The heated drying air makes it possible to absorb a higher proportion of steam. As a result, the drying process can be accelerated.

Alternatively or in addition, provision can be made for the drying air to be dehumidified before feeding to the drying chamber.

The heating device is advantageously arranged on the air guide part. For example, the air guide part is fixed to a chamber wall arrangement of the drying chamber, and the heating device is arranged in the intermediate space between the chamber wall arrangement and the air guide part. This allows firstly the chamber wall arrangement to be heated and secondly the drying air to be heated. Alternatively, the heating device can be integrated, for example, into the chamber wall arrangement. The drying air flowing along the chamber wall arrangement can also be heated in this way.

In practice, it can prove advantageous if the material to be dried is heated to preferably 70° C. or less in the drying chamber. In practice, for example, temperatures of approximately 50° C. prove advantageous. Although an acceleration of the drying process can be achieved at temperatures above approximately 60° C., it is desirable to maintain the highest possible population of microorganisms. Above approximately 60° C., however, a reduction in the concentration can occur for example, due to denaturation of the proteins of the microorganisms.

In practice, to heat the organic material, a temperature of the drying chamber, in particular the wall arrangement thereof, can preferably be approximately 70° C. The evaporation of water from the organic material results in cooling due to the withdrawal of evaporation heat, such that, for example, the approximately 50° C. results in the organic material.

If a ventilation device is used, an increase in the temperature of the heating device proves advantageous in order to achieve higher temperatures of the drying air. At higher temperatures, the drying air can remove a larger amount of steam from the drying chamber and thereby accelerate the drying process.

Temperatures of the organic material of up to approximately 80° C. can be provided, in which, in fact, certain types of microorganisms can exist. However, the variety of types is limited, and a lower temperature as explained above is advantageous.

In practice, it is found that temperatures of the organic material of less than approximately 40° C. extend the drying process due to the lower vapor pressure of water, which is why a higher temperature is preferred.

It is advantageous if the composting apparatus comprises a condensation device downstream of the drying chamber in the flow direction of the drying air, by means of which condensation device the drying air can be dehumidified and which comprises a condensate container for receiving the condensate. As already mentioned, the odor emission of the composting apparatus, for example, can be reduced by the dehumidification. Condensate (in particular water) can be collected in the condensate container. This condensate can be used, for example, for re-humidification in the composting chamber. This will be discussed below. Alternatively or in addition, the condensate, which can advantageously contain microorganisms, can be used for pouring purposes.

It is advantageous if the ventilation device can be controlled and/or regulated by the control device.

The composting apparatus preferably comprises at least one sensor device which is coupled to the control device. The at least one sensor device preferably comprises at least one sensor for detecting parameters on or in the drying chamber and/or on or in the composting chamber.

The composting apparatus advantageously comprises a sensor device coupled to the control device, which sensor device has a temperature sensor and/or a moisture sensor, the drying process being able to be controlled and/or regulated as a function of a signal from the sensor device. In this way, the best possible and/or desired drying result, for example with a desired degree of dryness, can be achieved. For example, a temperature of the organic material, an air temperature and/or a temperature of the chamber wall arrangement can be measured as the temperature. For example, a moisture of the organic material and/or an air humidity can be measured as the moisture.

The composting apparatus advantageously comprises a mixing unit by means of which the organic material to be dried, which is received in the drying chamber, can be mixed and/or shredded. This promotes the drying process. In particular, a surface of the organic material can be increased by shredding, in order to accelerate the drying process. In this way, an improved conversion to compost material in the subsequent composting step can advantageously also be made possible, in particular an acceleration of the composting process.

It can be provided that the at least one sensor device comprises a particle sensor, by means of which a particle size or a degree of shredding of the organic material can be determined.

The mixing unit can preferably be actuated by the control device and can, for example, comprise a drive device which can advantageously be controlled and/or regulated.

It is advantageous if the composting apparatus comprises a conveying unit by means of which dried organic material can be conveyed from the drying chamber into the composting chamber. Via the conveying unit, the organic material can be conveyed into the composting chamber through the opening mentioned at the outset and, for example, through the aforementioned channel, if present. In this case, as an alternative gravity can be used in particular. The conveying unit can preferably be actuated, specifically controlled and/or regulated by the control device.

It is expedient if the mixing unit comprises or forms the conveying unit. There is thus no need for a separate conveying unit. For example, in a preferred embodiment, it can be provided that the mixing unit mixes the organic material in a first operating mode, and acts as a conveying unit in a second operating mode. The operating modes can differ, for example, by mutually opposite directions of rotation of a rotatable mixing unit.

It can be provided that dried organic material can be transferred from the drying chamber into the composting chamber in accordance with at least one of the following:
after a predetermined residence time in the drying chamber has elapsed;
after determining a predetermined moisture content, in particular by means of the sensor device; at the request of a user, in particular via an operating element of the composting apparatus. In this case, for example, the user can be provided with information, on an output unit, that the organic material is dried and can be composted. Alternatively, as mentioned above, the user could remove the dried material of the drying chamber if an operating mode relating thereto is provided.
within the scope of a predetermined maximum amount and/or a predetermined minimum amount. For example, it can be provided that a maximum amount of the dried material in the composting chamber at the beginning of the composting process should not be exceeded in order to limit the duration of the composting process and/or to avoid overfilling of the composting chamber. Alternatively or in addition, it can be provided that, for energy-saving reasons, a minimum amount of organic material should be contained in the composting chamber at the beginning of the composting process.

The amount of material transferred into the composting chamber can be set, for example, on the basis of the operation of the aforementioned conveying unit.

In the present application, “predetermined” can in particular also include or mean “predeterminable”.

It can be advantageous if the composting apparatus comprises a sensor device coupled to the control unit for determining an amount of the transferred material. In this case, it can preferably be provided that the conveying unit can be controlled and/or regulated as a function of a signal from the sensor device.

In a preferred embodiment of the invention, a mass of the dried organic material transferred into the composting chamber can be determined, for example, via at least one weight sensor. For example, at least one load cell, via which the composting chamber is held on a support device of the composting apparatus, is used as the sensor in this regard.

It can be advantageous if the composting apparatus comprises a heating device arranged on the composting chamber for heating the material arranged in the composting chamber, which heating device can be controlled and/or regulated by the control device. The temperature in the composting chamber can be increased via the heating device, and the composting process can thereby be accelerated. It can be provided that the chamber wall arrangement of the composting chamber can be heated. For this purpose, the chamber wall arrangement is made, for example, of a metal. Alternatively or in addition, the chamber interior can be heated by the heating device.

The heating devices used in the present case can have various designs. For example, they are electrical heating devices.

It is advantageous if the composting device comprises a ventilation device via which air can be applied to the composting chamber for the composting process. In this way, an aerobic conversion of the dried organic material to form compost material is promoted. Odor emission having undesired odors of the composting apparatus can be reduced and preferably prevented.

When using the above-mentioned heating device, there is the advantage of avoiding possible undesired cooling in the composting chamber as a result of the supplied air.

The ventilation device can preferably comprise a pressure generating unit and an air guide part by means of which the air can be guided into the composting chamber. The pressure generating unit can be an overpressure unit or a negative pressure unit.

The air can be guided in a targeted manner into the composting chamber via the air guide part, in order to enable sufficient supply of (air) oxygen. Metabolic products, in particular CO₂ and H₂O, can be discharged from the composting chamber by means of the air.

It is advantageous if the air can be discharged from the composting chamber via the pressure generating unit already mentioned above. For example, the air having metabolic products contained therein is guided through the drying chamber and fed from there to the preferably provided condensation device. This allows the moisture contained in the air of the composting chamber to also be removed and fed to the condensate container.

The air can preferably be heated using the heating device. In this way, the composting process can be promoted and preferably accelerated via the heated air.

The heating device can be arranged, for example, on the air guide part. For example, the heating device is arranged between a chamber wall arrangement of the composting chamber and the air guide part. This gives the possibility of both heating the chamber wall arrangement and of heating the air flowing past the heating device.

Alternatively, it can be provided that the heating device is integrated into a chamber wall arrangement. In this case, the air flowing along the chamber wall arrangement can be heated.

It can be advantageous if the composting apparatus comprises a humidifying device for supplying liquid to the composting chamber. This makes it possible, if necessary, to introduce liquid (in particular water) into the composting chamber. This can prove advantageous for the progression of composting process. For example, the microorganisms in the organic material are reactivated by re-humidifying, such that the degradation to compost material is accelerated.

The humidification device can preferably comprise a storage container for the liquid. The storage container can expediently be the condensate container of the aforementioned condensation device. In the latter case, the condensate obtained during the drying process can be used for the composting process. Ideally, it is not necessary for the user to add liquid separately.

The humidification device preferably comprises a conveying unit for conveying the liquid. For example, a pump which can be actuated by the control device is provided, by means of which liquid is conveyed out of the storage container.

The liquid is preferably supplied to an upper side of the composting chamber in order to enable a more uniform humidification from above. For example, a nozzle for distributing the liquid is provided.

It is found to be advantageous if the heating device at the composting chamber, the ventilation device for the composting chamber and/or the humidification device can be controlled and/or regulated by the control device.

It is advantageous if the composting apparatus comprises a sensor device coupled to the control device, which sensor device has a temperature sensor and/or a moisture sensor, and if the composting process can be controlled and/or regulated as a function of a signal of the sensor device.

Alternatively or in addition, for example, a signal of a weight sensor and/or a particle sensor of the sensor device can be evaluated and, as a function thereof, the composting process can be controlled and/or regulated.

The composting apparatus advantageously comprises a mixing unit by means of which the organic material received in the composting chamber can be mixed and/or shredded. In this way, in particular the surface of the material can be enlarged with regard to an improved composter result. Alternatively or in addition, the ventilation is improved via the ventilation device and/or the humidification via the humidification device.

The mixing unit comprises, for example, a drive device which can be controlled and/or regulated by the control device.

It can be provided that the compost material can be removed from the composting chamber after termination of the composting process. For this purpose, said chamber can be opened or closed, for example. Alternatively or in addition, it can be provided that the composting chamber of the composting apparatus can be removed.

Alternatively or in addition, it is advantageous if the composting apparatus comprises a removal container and a conveying unit, by means of which compost material can be conveyed from the composting chamber into the removal container. For example, the removal container of the composting apparatus can be removed in a user-friendly manner, and compost material contained therein can be supplied for use. The conveying unit is advantageously actuatable by the control device.

It is advantageous if the mixing unit comprises or forms the conveying unit. There is thus no need for a separate conveying unit for discharging the compost material. It can be provided, for example, that the mixing unit can have different operating modes. For example, the organic material is circulated in the composting chamber in a first operating mode, and discharged via a discharge opening in a second operating mode. The operating modes differ, for example in the case of a mixing unit rotatable about an axis, by mutually opposing directions of rotation.

The compost material can be transferred from the composting chamber into the removal container, in accordance with preferably at least one of the following:
after a predetermined residence time in the composting chamber has elapsed;
after determining a predetermined moisture content;
at the request of the user, in particular via an operating element of the composting apparatus;
as a function of a determined concentration of a reactant and/or a reaction product in the composting process, for example in the case of aerobic degradation. For example, a change in concentration of a gaseous reactant, in particular (air) oxygen and/or a CO₂ or H₂O concentration, is detected using a sensor element of the sensor device mentioned below.

It can be provided, for example, that information can be provided to the user on an output unit, said information relating to the completion of the composting process. Alternatively or in addition, the user can, for example, on their own initiative terminate the composting process in order to dispense compost material.

It can be provided that the composting apparatus comprises a sensor device coupled to the control unit for determining an amount of the transferred compost material, the conveying unit on the composting chamber being controllable and/or regulatable in particular as a function of a signal from the sensor device.

By means of the composting device, a fresh compost having a degree of aging of greater than or equal to III can advantageously be produced.

As already mentioned, the composting process is carried out by means of microorganisms, which are preferably contained in the dried organic material. There is thus no need for the addition of microorganisms.

It is advantageous if compost material can be heated for a predetermined period of time and/or to a predetermined temperature by means of a heating device, for hygienization. In this way, microorganisms still present in the compost material can be deactivated or killed. Any residual moisture in the compost material can advantageously be expelled. The hygienization can prevent any further activity in the compost material and thereby ensure that no further uncontrolled degradation and no mold formation can take place. The compost material preferably contains no pathogenic or phytopathogenic germs so that it is harmless when handled by the user and when used with plants.

During the hygienization step, the temperature of the compost material is preferably approximately 70° C. to 120° C. In practice, temperatures above 80° C. can prove advantageous. A temperature of approximately 90° C. to 100° C. is even more favorable. A temperature over approximately 120° C. can prove to be disadvantageous since, in practice, increased adhesion of compost material to the wall arrangement of the composting chamber or to the mixing unit can occur.

Hygienization is advantageously carried out for a period of at least one hour, advantageously at least two hours. Higher temperatures allow shortened hygienization durations.

The hygienization can preferably be carried out in the composting chamber, in particular with the heating device arranged thereon. Alternatively or in addition, the hygienization can be carried out, for example, in the aforementioned removal container.

It has already been mentioned above that the composting apparatus can have two operating modes. If an operating mode is used in which the organic material is only dried but is not composted, a hygienization step can preferably be provided for the dried, non-composted material.

For this purpose, the material can, for example, be transferred into the composting chamber and heated therein for a predetermined period of time and/or to a predetermined temperature for hygienization. The microorganisms contained in the dried material are deactivated or killed so that further decomposition can be avoided.

The present invention also relates to a method for providing compost material from organic material, in particular using a composting apparatus of the type mentioned above or below, the method comprising:
heating and drying organic material to be composted, in a drying chamber;
transferring dried organic material into a composting chamber and converting the material in the composting chamber to form compost material.

The advantages which can be achieved by the composting apparatus in accordance with the invention can likewise be achieved using the method in accordance with the invention. Advantageous embodiments of the composting apparatus in accordance with the invention, which are explained below, can be implemented in order to form advantageous exemplary embodiments of the method in accordance with the invention. For this reason, in order to avoid repetition, preferred embodiments of the composting apparatus will be discussed below, without supplementary statements relating thereto being made in relation to preferred embodiments of the method in accordance with the invention.

The method in accordance with the invention and its advantageous embodiments have already been discussed above. In particular, a method can be carried out in which organic material is dried in a drying chamber and is subsequently composted in a composting chamber. Preferably, the compost material is subsequently hygienized, for example in the composting chamber or in a removal container.

If the composting step is omitted, the dried material can optionally also be hygienized.

The operation of the drying chamber and the operation of the composting chamber can advantageously be carried out independently of one another. By means of the control device, in particular the above-mentioned advantageously provided devices (heating, ventilation, humidification, condensing) and/or the preferably provided units (mixing unit, conveying unit) can be operated, and in particular controlled and/or regulated, independently of one another. Advantageously, the user is given the possibility of introducing further organic material into the drying chamber during an ongoing drying process while a composting process is carried out. It can be provided that a composting process is carried out without organic material being contained in the drying chamber. It can be provided that compost material is produced in the composting chamber, following the extraction of which into the removal chamber, for example, further dried organic material is supplied from the drying chamber for a subsequent composting process.

The composting apparatus can have an operating unit which can comprise an input unit and/or an output unit. For example, inputs by the user can be carried out on the composting apparatus itself. The same applies to outputs of the composting apparatus.

Alternatively or in addition, for example, an external peripheral device can be used, for example a Smartphone or a tablet computer. Inputs can advantageously be made and outputs provided on the external peripheral device. For this purpose, a user application program in this regard, in particular in the form of what is known as an “App”, can preferably be stored in an executable manner on the auxiliary device.

It may accordingly be advantageous if the composting apparatus comprises an interface for establishing a communication connection with an external peripheral device, and if inputs of the user on the peripheral device for operating the composting apparatus can be transmitted to the control device, and/or if outputs of the control device regarding the state of the composting apparatus can be transmitted for outputting to the peripheral device.

The following description of a preferred embodiment of the invention serves in conjunction with the drawing to explain the invention in more detail.

The preferred embodiment of the composting apparatus in accordance with the invention explained below, which is denoted as a whole by the reference numeral 10 in the drawing, serves to implement a preferred embodiment of the method in accordance with the invention. The composting apparatus 10 is referred to in simplified form below as apparatus 10.

The apparatus 10 is provided in particular for domestic use and serves to provide compost material 12 after decomposition of a starting material, which is an organic material 14 to be composted. The organic material 14 comprises, for example, kitchen waste or small plants. The apparatus 10 can also be used in offices, for example.

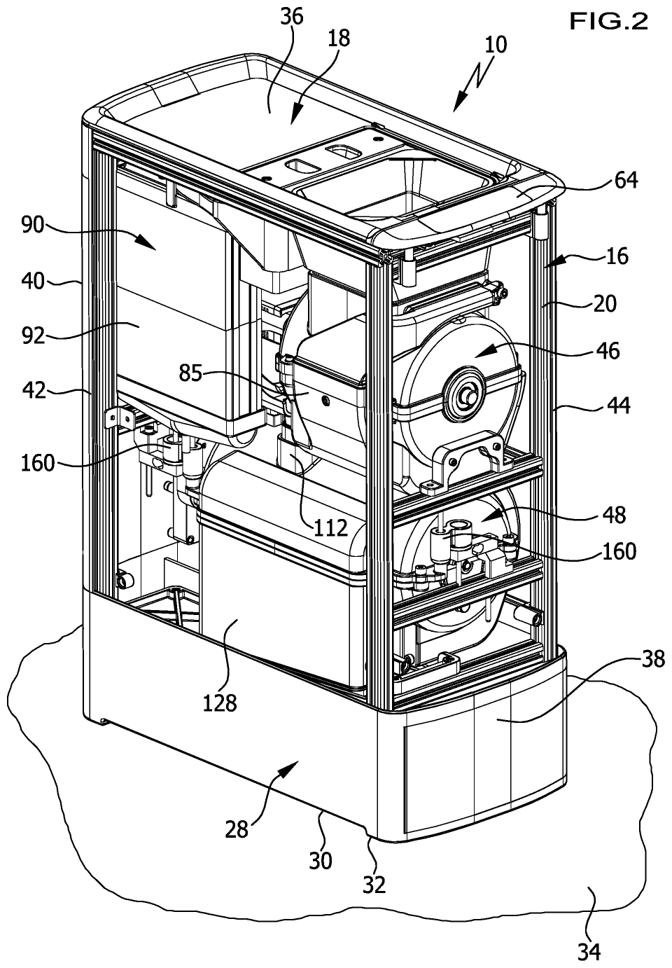

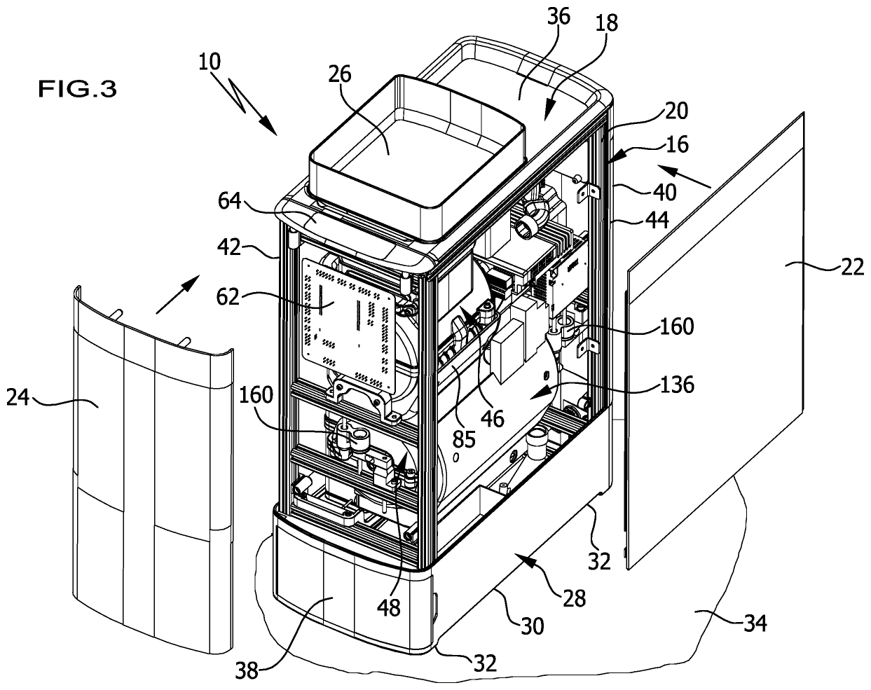

The apparatus 10 comprises a support device 16 having a housing 18, the wall arrangements of which are held on a frame 20. Side walls of the housing 18 are hidden in FIG. 2. FIG. 3 shows a side wall 22 and a front wall 24 away from the frame 20 in order to free up the view into the housing 18. In FIG. 2, a cover element 26, which can preferably be manually opened, is also faded out.

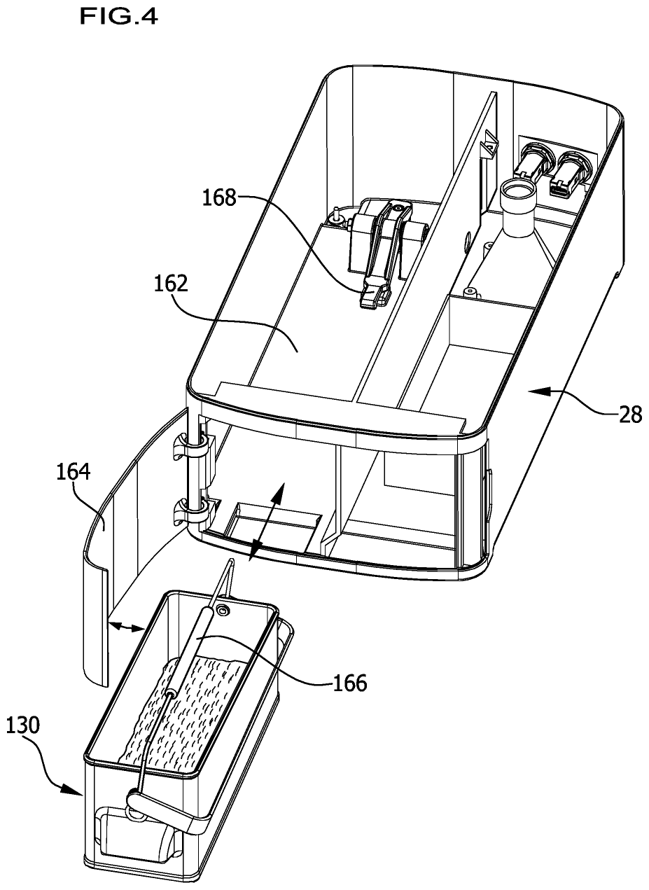

The housing 18 comprises a lower portion 28, which is shown in FIGS. 4 to 7.

When used as intended, the apparatus 10 can, for example, be positioned on a set-down surface 34, for example a floor surface, via a placement device 32 formed by an underside 30. The set-down surface 34 can be considered, in a non-limiting manner, to be oriented horizontally.

Position and orientation information relates to a use of the apparatus 10 as intended, in which said apparatus is positioned in particular upright on the set-down surface 34. The underside 30 is opposite an upper side 36. The apparatus 10 further comprises a front side 38, the front wall 24 already mentioned being arranged thereon, and a rear side 40 opposite said front wall. Furthermore, a left-hand side 42 and a right-hand side 44 are provided.

The apparatus 10 comprises a first chamber, hereinafter referred to as drying chamber 46, as well as a second chamber, which is referred to hereinafter as a composting chamber 48.

In the present embodiment, the drying chamber 46 is substantially cylindrical, an axis of the drying chamber 46 being oriented substantially in parallel with the plane of the placement device 32 (in the present case horizontally).

The drying chamber 46 comprises a wall arrangement 50, which comprises a jacket-like outer wall 52 and an end wall 54 on the front side and an end wall (not shown in the drawings) on the rear side.

On the upper side of the outer wall 52, an introduction opening 56 is formed. Via the introduction opening 56, organic material 14 can be introduced through a channel 58 into the interior 60 of the drying chamber 46. In the present case, the channel 58 is designed as a shaft.

The cover element 26 is arranged on the upper side 36, said cover element being designed, for example, as a slider or as a flap. The channel 58 can be closed on the upper side by means of the cover element 26.

The apparatus 10 comprises a control device 62. The control device 62 is coupled to the heating devices, the ventilation device, the condensation device, the humidification device and the mixing units explained below, and can actuate them. In particular, the respective operation thereof can preferably be regulated. In this way, the operation of the drying chamber 46 and the operation of the composting chamber 48 can be controlled and/or regulated, in particular independently of one another.

The control device 62 is operatively connected to an operating unit 64, which comprises an input unit 66 and an output unit 68 for a user.

Furthermore, the control device 62 is preferably connected to an external accessory device 70, in a preferably wireless connection. Via the external accessory device 70, for example a Smartphone, inputs and outputs can be made to the input unit and output unit thereof. For this purpose, a touch-sensitive screen 72 (touchscreen) can be used, for example. A user application program in the form of what is known as an App, via which the apparatus 10 can be operated and which can provide information to the apparatus 10, can be stored on the accessory device 70.

A heating device 74 is arranged on the drying chamber 46. In the present case, the heating device 74 comprises an electrically configured heating element 76. The heating element 76 serves to heat the wall arrangement 50. In this way, the organic material 14 to be dried, arranged in the interior space 60, can be heated.

The apparatus 10 comprises a ventilation device 78 for providing drying air at or in the drying chamber 46. The ventilation device 78 comprises a first pressure generating unit 80 and a second pressure generating unit 82. The pressure generating unit 80 serves to generate an overpressure and is designed as a fan 81 which sucks in ambient air from the atmosphere. The ambient air is blown into the housing 18.

The pressure generating unit 82 serves to generate a negative pressure in the drying chamber 46 and in the composting chamber 48 and is also designed as a fan 83. Exhaust air of the fan 83 can be discharged into the atmosphere.

The ventilation device 78 comprises an air guide part 85 which serves to guide drying air on the drying chamber 46. For this purpose, the air guide part 85 surrounds the outer wall 52 in portions.

Air from the interior of the housing is sucked into the air guide part 85 (arrow 87) and flows from there into an intermediate space between the outer wall 52 and the air guide part 85. The heating element 76 is positioned in the intermediate space. In this way, besides the wall arrangement 50, the drying air is heated by means of the heating device 74.

The drying air is guided to the introduction opening 56 via the air guide part 85. The drying air flows across the introduction opening 56 and can also reach the interior space 60.

The ventilation device 78 further comprises a channel 88 into which the drying air enters.

By heating the material 14, liquid, in particular water, evaporates. In this way, the material 14 is dried in the drying chamber 46. Water vapor is absorbed by the drying air and discharged into the channel 88. In this way, the drying process is promoted.

The fact that organic material 14 is dried in the drying chamber 46 prevents uncontrolled decomposition and in particular fermentation in the drying chamber 46. This also prevents undesired odor emission due to uncontrolled decomposition. Furthermore, the dried organic material 14 can be kept or stored in the drying chamber 46 for a longer time without decomposition processes and odor formation.

In the drying chamber 46, the organic material 14 is dried in particular gently, the highest possible population of microorganisms being maintained. The subsequent composting can thereby proceed in an accelerated manner. Preferably, no addition of microorganisms and/or other types of compost accelerators is required. The microorganisms contained in the dried organic material 14 can preferably be “re-activated” in a targeted manner during the composting process.

It is shown, for example, in practice that a temperature of the drying chamber 46 of approximately 70° C. is advantageous. The material 14 can thereby be heated to a temperature of, for example, approximately 50° C. As a result, a sufficiently rapid drying process can be carried out. Furthermore, it is avoided that the microorganisms are killed by excessively high temperature, and the above-described high population can be maintained. Due to the temperature of approximately 70° C., the drying air can discharge relatively high amounts of steam from the drying chamber 46, with a view to rapid drying.

Depending on the operating mode in which the apparatus 10 is operated, the material 14 can be fed to the composting chamber 48, for compositing, in the dried state—this will be discussed in the following. Otherwise, the dried organic material 14 can be removed from the drying chamber 46. For this purpose, the material can, for example, be transferred into the composting chamber 48 and from this composting chamber 48, without a previous composting process, into the removal container mentioned below. The removal container can be removed by the user and the material 14 can be disposed of, for example, in an organic waste collection bin.

The apparatus 10 comprises a condensation device 90. The condensation device 90 is arranged downstream of the drying chamber 46 in the direction of flow of the drying air and is in particular connected into the channel 88. The condensation device 90 comprises a condenser 92. Furthermore, the condensation device 90 comprises a condensate container 94, which is fluidically connected to the condenser 92 via a line 96.

Steam contained in the drying air condenses in the condenser 92. As a result, the drying air is dehumidified. The condensate flows via the line 96 into the condensate container 94 and is collected therein.

The drying air flows further through the channel 88, into which a filter element 98 is connected downstream of the condenser 92. The filter element 98 comprises, for example, an activated carbon filter.

The filtered drying air is discharged into the atmosphere via the fan 83. Due to the dehumidification and additional filtering, odor formation can be largely avoided. Furthermore, the dehumidification ensures that any objects in the surroundings of the apparatus 10 cannot be attacked by moisture and be damaged.

The air blown into the housing 18 via the fan 81 is used in particular for cooling the condenser 92. As a result, the air can be preheated. This makes it possible, for example, to keep the heating power for heating the drying air for the drying chamber 48 and the air sucked into the composting chamber 50 low.

For mixing and shredding the organic material 14 in the drying chamber 46, the apparatus 10 comprises a mixing unit 100. The mixing unit 100 comprises mixing elements 102 and a drive device 104. The mixing unit 100 is rotatably drivable about an axis 106. In the present case, the axis 106 coincides with the axis of the drying chamber 46. The mixing elements 102 can be designed to be rigid or movable.

The surface of the organic material 14 is enlarged by circulating and shredding. This accelerates the drying process. Furthermore, the organic material 14 is prepared for simplified and accelerated performance of the composting process.

The drying chamber 46 and the composting chamber 48 are connected to one another via at least one opening for transferring material. In the present case, a discharge opening 108 of the drying chamber 46 and an introduction opening 110 of the composting chamber 48 are provided.

The discharge opening 108 is formed, for example, on the rear end wall of the drying chamber 46. The introduction opening 110 is preferably formed on the upper side of the composting chamber 48.

In the present embodiment, a channel 112 is formed between the drying chamber 46 and the composting chamber 48. The channel 112 is designed as a shaft.

For the transfer of organic material 14, which is to be dried for composting, into the composting chamber 48, on the one hand, gravitational force can be effective. For this purpose, the drying chamber 46 is arranged above the composting chamber 48. The channel 112 extends at least in portions in a height direction, in particular vertically.

On the other hand, the apparatus 10 comprises a conveying unit by means of which the material 14 can be transferred via the channel 112 into the composting chamber 48. It is advantageous in the present example that the mixing unit 100 forms the conveying unit.

For this purpose, the direction of rotation of the mixing unit 100 may be reversed relative to the circulation during the drying process. As a result of the reversal of the direction of rotation, the material 14 can be conveyed through the discharge opening 108 into the channel 112.

The apparatus 10 comprises a sensor device 114. The sensor device 114 comprises at least one and preferably a plurality of sensors and is coupled to the control device 62. In particular, a temperature sensor and a moisture sensor can be provided. Furthermore, a particle sensor and/or a weight sensor is conceivable. Based on the signal of the sensor device 114, the control device 62 can control the drying process and in this case in particular control and/or regulate the heating device 74, the ventilation device 78, the condensation device 90 and the mixing unit 100.

The composting chamber 48 comprises a wall arrangement 116. The wall arrangement 116 encloses an interior 118. The interior 118 is in particular a reaction chamber.

In the present case, the composting chamber 48 is substantially cylindrical and has a wall arrangement 116. The wall arrangement 116 comprises a jacket-like outer wall 122. An end wall 124 is provided on the front side 40. Furthermore, a rear end wall (not shown in the drawing) is provided. The introduction opening 110 is formed on the upper side in the wall arrangement 116.

Furthermore, the composting chamber 48 has a discharge opening 126. In the present case, the discharge opening 126 is formed in the outer wall 122. The discharge opening 126 is in particular a jacket opening, which is designed in a substantially slot-like manner. The discharge opening 126 extends for example in parallel with an axis of the composting chamber 48.

The axes of the drying chamber 46 and the composting chamber 48 are preferably oriented in parallel with one another.

A channel 128 is connected to the composting chamber 48 and is molded for example onto the composting chamber 48 or the components thereof. In the present case, the channel 128 is designed as a shaft and extends downwards, substantially from the composting chamber 48.

The discharge opening 126 opens into the channel 128. On the underside, the channel 128 opens into a removal container 130.

During use as intended, the removal container 130 is connected to the channel 128 via a seal. In a corresponding manner, there is a sealed connection of the channel 128 to the composting chamber 48 and a sealed connection between the chambers 46 and 48 via the channel 112. Furthermore, the cover element 26 can tightly close the opening on the upper side 36. An odor emission, in particular the escape of unpleasant odors, can thereby be largely avoided. This also applies, in particular, because the drying chamber 46, as already explained, and also the composting chamber 48, as explained below, are exposed to negative pressure with respect to the atmosphere due to the fans 81, 83.

The apparatus 10 comprises a further heating device 132 having a further heating element 134. For example, the heating element 134 is configured electrically. By means of the heating device 132, the interior 118 and the organic material 14 contained therein can be heated during the composting process. For this purpose, it is advantageous for the wall arrangement 116 to be made of metal.

Furthermore, a ventilation device is preferably provided for supplying air for the composting process. This can be a ventilation device that is separate from the ventilation device 78. It is advantageous for the structural design of the apparatus 10 that, in the present example, the ventilation device 78 is used to supply air to the composting chamber 48.

For this purpose, the ventilation device 78 comprises an air guide part 136. In the present case, the air guide part 136 is arranged on the outside of the wall arrangement 116. In this case, the air guide part 136 surrounds the wall arrangement 116 at least in portions.

The heating element 134 is arranged in the intermediate space between the wall arrangement 116 and the air guide part 136.

Air from the interior of the housing 18 can be sucked into the intermediate space (arrow 138). As a result, the air flows past the heating element 134 and is likewise preheated to promote the composting process.

The air guide part 136 opens into the channel 128.

The air flows through the air guide part 136 and the channel 128 into the interior 118. In this way (air) oxygen can be provided for the composting process in order to promote aerobic composting.

Furthermore, the air flows through the channel 112 and the drying chamber 46 into the channel 88. Any steam in the interior 118 can be absorbed by the air. Moisture can condense in the condenser 92.

The apparatus 10 comprises a further mixing unit 140 having mixing elements 142 and a drive device 144. The mixing unit 140 serves for circulating the material 14 in the interior 118. The mixing elements 142 can be configured to be rigid or movable.

In the present case, the mixing unit 140 is rotatably drivable about an axis 146. In the present example, the axis 146 coincides with the axis of the composting chamber 48.

The apparatus 10 comprises a humidification device 148. A liquid can be supplied in a targeted manner via the humidification device 148 to the composting chamber 48. As a result of the preferably targeted humidification, microorganisms are preferably reactivated in the organic material 14 in order to accelerate the composting process.

The humidification device 148 comprises a conveying unit 150, in the present case designed as a pump 152. Furthermore, the humidification device 148 comprises a reservoir for a liquid. In the present case the condensate container 94 is used as a storage container. This makes it possible to use the condensate obtained during the dehumidification for the re-humidification of the material 14 during the composting process.

A line 154, into which the pump 152 is connected, leads liquid to a nozzle 156 which is directed into the interior 118.

The apparatus 10 comprises a further sensor device 158 which is coupled to the control device 62. The sensor device 158 comprises at least one and preferably a plurality of sensors. For example, a temperature sensor and a moisture sensor are provided. Furthermore, a weight sensor is advantageously provided in order to determine the amount of material 14 which is transferred into the composting chamber 48.

In the present example, load cells 160 are provided as weight sensors, via which the composting chamber 48 is held on the frame 20. As a result, the operation of the mixing unit 100 can be controlled such that, advantageously, on the one hand, a minimum amount of organic material 14 is exceeded, and, on the other hand, a maximum amount is not exceeded, with regard to a preferred progression of the composting process.

As a function of the signal from the sensor device 158, the control device 62 can control the composting process, in particular the heating device 132, the ventilation device 78, the humidification device 148 and/or the mixing unit 140 can be controlled and/or regulated.

In order to discharge compost material 12 after the composting process, the apparatus 10 comprises a conveying unit. In the present case, it is advantageous for the conveying unit to be formed by the mixing unit 140. For circulating the material 14 in the composting chamber 48, the mixing unit 140 can be rotated about the axis 146. The direction of rotation can be reversed for use as a conveying unit. This allows the compost material 12 to be pushed via the mixing elements 142 to the discharge opening 126 and thereby to be conveyed into the channel 128. The compost material 12 falls through the channel 128 into the removal container 130.

Before the composting material 12 is discharged, a hygienization step can be carried out in the composting chamber 48. In this case, the compost material 12 can be heated to a predetermined temperature for a predetermined time duration in order to kill or deactivate microorganisms and fungi. The temperature is, for example, approximately 80° C. to 120° C. In practice, for example approximately 90° C. to 100° C. is found to be advantageous. The time duration is preferably more than 1 hour, in particular more than 2 hours.

The hygienization step can be carried out in a manner that is controlled and/or regulated by the control device 62.

The residence time of the organic material up to the formation of the compost material can be, for example, approximately 24 to 48 hours or more.

A hygienization step can also be carried out in the operating mode in which the organic material 14 is only dried but not composted. For example, the dried organic material 14 can be transferred into the composting chamber 48 and be hygienized therein before further transport into the removal container 130.

During operation of the apparatus 10, the operation of the drying chamber 46 and the operation of the composting chamber 48 can be carried out independently of one another. In particular, the drying process and the composting process can be carried out simultaneously or at different times. It is also possible for further organic material 14 to be introduced into the drying chamber 46 while the drying process and/or the composting process take place.

In operation, it is provided, for example, that the user is informed by the output unit that the drying process has ended. The user can trigger the subsequent composting process via the input unit.

Furthermore, it can be provided during operation that the user is informed via the output unit of the termination of the composting process. It can be provided that this only takes place when compost material 12 is conveyed into the removal container 130.

The removal container 130 is arranged in a receptacle 162 of the lower portion 28 (FIG. 4). A cover element 164, flap-like in the present example, may be opened to remove the removal container 130. For transport, a handle can be provided, for example a bow handle 166.

A preloading device 168 is provided on the lower portion 28. The removal container 130 is subjected to a force directed in the direction of the channel 128 via the preloading device 168 in order to ensure a tight connection to said channel.

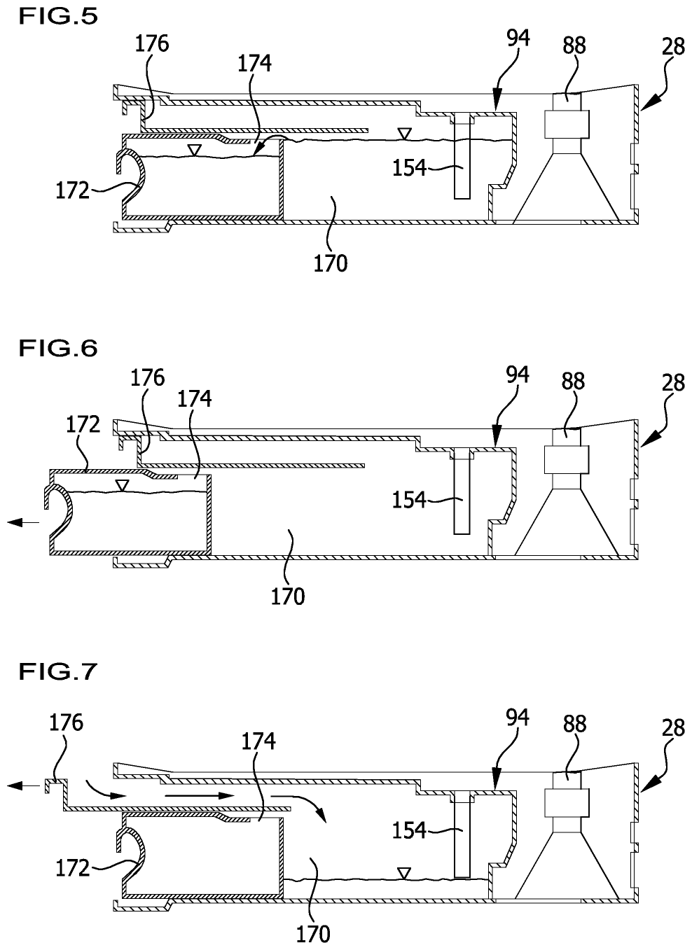

As will be explained below with reference to FIGS. 5 to 7, the condensate container 94 can be designed in multiple parts.

In the present example, the condensate container 94 is arranged on the lower portion 28 and is positioned, for example, laterally next to the removal container 130. The condensate can be transferred into a first container portion 170. For example, the line 154 engages in the first container portion 170.

The condensate container 94 can further comprise a second container portion 172. The second container portion 172 can be in fluid communication with the first container portion 170 via an overflow opening 174. The overflow opening 174 is preferably designed in a sealing manner.

In the event that the liquid level in the first container portion 170 rises, liquid can flow via the overflow opening 174 into the second container portion 172 (FIG. 5). The second container portion 172 can be removed from the lower portion 28 for emptying (FIG. 6).

If the liquid level in the condensate container 94 is not high enough to suction liquid by means of the pump 152, a filling element 176 of the condensate container 94 can be used (FIG. 7). The filling element 176 is, for example, a trough element or funnel element. The filling element 176 can be pulled out, for example, to allow liquid to be introduced into the first container portion 170.

### LIST OF REFERENCE SIGNS

10 Composting apparatus (apparatus)

12 Compost material

14 Organic material

16 Support device

18 Housing

20 Frame

22 Side wall

24 Front wall

26 Cover element

28 Lower portion

30 Underside

32 Placement device

34 Set-down surface

36 Upper side

38 Front side

40 Rear side

42 Left-hand side

44 Right-hand side

46 Drying chamber

48 Composting chamber

50 Wall arrangement

52 Outer wall

54 End wall

56 Introduction opening

58 Channel

60 Interior

62 Control device

64 Operating unit

66 Input unit

68 Output unit

70 External accessory device

72 Screen

74 Heating device

76 Heating element

78 Ventilation device

80, 82 Pressure generating unit

81, 83 Fan

85 Air guide part

87 Arrow

88 Channel

90 Condensation device

92 Condenser

94 Condensate container

96 Line

98 Filter element

100 Mixing unit

102 Mixing element

104 Drive device

106 Axis

108 Discharge opening

110 Introduction opening

112 Channel

114 Sensor device

116 Wall arrangement

118 Interior

122 Outer wall

124 End wall

126 Discharge opening

128 Channel

130 Removal container

132 Heating device

134 Heating element

136 Air guide part

138 Arrow

140 Mixing unit

142 Mixing element

144 Drive device

146 Axis

148 Humidification device

150 Conveying unit

152 Pump

154 Line

156 Nozzle

158 Sensor device

160 Load cell

162 Receptacle

164 Cover element

166 Bow handle

168 Preloading device

170, 172 Container portion

174 Overflow opening

176 Filling element

1. Composting device for providing compost material from organic material, comprising:
a drying chamber for receiving organic material to be composted;
a heating device located on the drying chamber for heating the organic material located in the drying chamber;
a control device for at least one of controlling and regulating the heating device; and
a composting chamber, which is connected to the drying chamber via an opening for material transfer and in which the organic material that has been dried in the drying chamber is convertible into compost material.

2. Composting apparatus in accordance with claim 1, wherein the composting apparatus has a first operating mode in which the organic material is dried in the drying chamber and fed to the composting chamber for controlled composting, and a second operating mode in which the organic material is dried in the drying chamber only to avoid uncontrolled composting processes and fermentation.

3. Composting apparatus in accordance with claim 1, wherein the composting apparatus comprises a ventilation device via which drying air is applicable to the drying chamber.

4. Composting apparatus in accordance with claim 3, wherein the ventilation device comprises a pressure generating unit and an air guide part, by means of which drying air is guidable into the drying chamber or to an opening of the drying chamber.

5. Composting apparatus in accordance with claim 4, wherein the drying air is heatable by means of the heating device, wherein the heating device is arranged on the air guide part.

6. Composting apparatus in accordance with claim 3, wherein the composting apparatus comprises a condensation device downstream of the drying chamber in the flow direction of the drying air, by means of which the drying air is dehumidifiable and which comprises a condensate container for receiving the condensate.

7. Composting apparatus in accordance with claim 3, wherein the ventilation device is at least one of controllable and regulatable by the control device.

8. Composting apparatus in accordance with claim 1, wherein the composting apparatus comprises a sensor device coupled to the control device, which sensor device has at least one of a temperature sensor and a moisture sensor, and wherein the drying process is at least one of controllable and regulatable as a function of a signal of the sensor device.

9. Composting apparatus in accordance with claim 1, wherein the composting apparatus comprises a mixing unit by means of which the organic material to be dried, which is received in the drying chamber, is at least one of mixable and shreddable.

10. Composting apparatus in accordance with claim 1, wherein the composting apparatus comprises a conveying unit by means of which dried organic material is conveyable from the drying chamber into the composting chamber.

11. Composting apparatus in accordance with claim 10, wherein the mixing unit comprises or forms a conveying unit by means of which dried organic material is conveyable from the drying chamber into the composting chamber.

12. Composting apparatus in accordance with claim 1, wherein dried organic material is transferable from the drying chamber into the composting chamber in accordance with at least one of the following:
after a predetermined residence time in the drying chamber has elapsed;
after determining a predetermined moisture content;
at the request of a user;
at the request of a user via an operating element of the composting apparatus;
within the scope of at least one of a predetermined maximum amount and a predetermined minimum amount.

13. Composting apparatus in accordance with claim 1, wherein the composting device comprises a sensor device coupled to the control unit for determining an amount of the transferred material.

14. Composting apparatus in accordance with claim 13, wherein the conveying unit is at least one of controllable and regulatable as a function of a signal of the sensor device.

15. Composting apparatus in accordance with claim 1, wherein a weight sensor is provided, via which a mass of the dried organic material transferred into the composting chamber is determinable.

16. Composting apparatus in accordance with claim 1, wherein the composting apparatus comprises a heating device arranged on the composting chamber for heating the material arranged in the composting chamber, which heating device is at least one of controllable and regulatable by the control device.

17. Composting apparatus in accordance with claim 1, wherein the composting apparatus comprises a ventilation device via which air is applicable to the composting chamber for the composting process.

18. Composting apparatus in accordance with claim 17, wherein the ventilation device comprises a pressure generating unit and an air guide part by means of which the air is guidable into the composting chamber.

19. Composting apparatus in accordance with claim 18, wherein the air is heatable by means of a heating device, wherein the heating device is arranged on the air guide part.

20. Composting apparatus in accordance with claim 1, wherein the composting apparatus comprises a humidification device for supplying liquid to the composting chamber.

21. Composting apparatus in accordance with claim 20, wherein the humidification device comprises a storage container for the liquid.

22. Composting apparatus in accordance with claim 21, wherein the composting apparatus comprises a condensation device downstream of the drying chamber in the flow direction of drying air, by means of which the drying air is dehumidifiable and which comprises a condensate container for receiving the condensate, and wherein the storage container is the condensate container.

23. Composting apparatus in accordance with claim 20, wherein the humidification device comprises a conveying unit for conveying the liquid.

24. Composting apparatus in accordance with claim 20, wherein the liquid is suppliable to an upper side of the composting chamber.

25. Composting apparatus in accordance with claim 1 wherein at least one of a heating device on the composting chamber, a ventilation device for the composting chamber and a humidification device for supplying liquid to the composting chamber is at least one of controllable and regulatable by the control device.

26. Composting apparatus in accordance with claim 1, wherein the composting apparatus comprises a sensor device coupled to the control device having at least one of a temperature sensor and a moisture sensor, and wherein the composting process is at least one of controllable and regulatable as a function of a signal of the sensor device.

27. Composting apparatus in accordance with claim 1, wherein the composting apparatus comprises a mixing unit by means of which the organic material received in the composting chamber is at least one of mixable and shreddable.

28. Composting apparatus in accordance with claim 1, wherein the composting apparatus comprises a removal container and a conveying unit by means of which the compost material is conveyable from the composting chamber into the removal container.

29. Composting apparatus in accordance with claim 28, wherein the composting apparatus comprises a mixing unit by means of which the organic material received in the composting chamber is at least one of mixable and shreddable, and wherein the mixing unit comprises or forms the conveying unit.

30. Composting apparatus in accordance with claim 28, wherein compost material is transferable from the composting chamber into the removal container in accordance with at least one of the following:
after a predetermined residence time in the composting chamber has elapsed;
after determining a predetermined moisture content;
at the request of a user;
at the request of a user via an operating element of the composting apparatus;
as a function of a determined concentration of a at least one of a reactant a reaction product in the composting process, for example in the case of aerobic degradation.

31. Composting apparatus in accordance with claim 30, wherein the composting apparatus comprises a sensor device coupled to the control unit for determining an amount of the transferred compost material.

32. Composting apparatus in accordance with claim 31, wherein the conveying unit is at least one of controllable and regulatable as a function of a signal from the sensor device.

33. Composting apparatus in accordance with claim 1, wherein compost material is heatable by means of a heating device for a predetermined time duration and/or to a predetermined temperature for hygienization.

34. Composting apparatus in accordance with claim 1, wherein the drying chamber and the composting chamber are operated independently of one another.

35. Composting apparatus in accordance with claim 1, wherein the composting apparatus comprises an interface for establishing a communication connection with an external peripheral device, and wherein inputs by the user on the peripheral device are transmittable to the control device for operating the composting device, and/or wherein outputs of the control device relating to the state of the composting apparatus are transmittable to the peripheral device for outputting.

36. Method for providing compost material from organic material, said method comprising:
heating and drying organic material to be composted, in a drying chamber;
transferring dried organic material into a composting chamber and converting the material in the composting chamber to form compost material.
